(19) United States
(12) Patent Application Publication
(10) Pub. No.: US 2004/0098715 A1
(43) Pub. Date: May 20, 2004

(54) Over the air mobile device software management

(76) Inventors: Parixit Aghera, Keshod (IN); Alan Bok, Naperville Illinois, IL (US); Suresh Kumar Chintada, Bangalore (IN); Sudharshana Madhara Rao, Bangalore (IN); Antonella Rinaldi, Turin (IT)

Correspondence Address: MOTOROLA, INC., 1303 EAST ALGONQUIN ROAD, IL01/3RD, SCHAUMBURG, IL, 60196

(21) Appl. No.: 10/652,352

(22) Filed: Aug. 29, 2003

Related U.S. Application Data
(60) Provisional application No. 60/407,453, filed on Aug. 30, 2002.

(51) Int. Cl. G06F 9/44; G06F 9/445; H04L 9/32

(52) U.S. Cl. 717/173; 717/178; 713/191

(57) ABSTRACT

An architecture for over the air management of software on a wireless device includes a software architecture supporting software patches, including secure downloading of software from a data network and robust installation of the same on the wireless device. Using this architecture, a network operator can notify a mobile device user about the software upgrade and send the upgrade to the mobile device over the air. Remote management of DSP software on mobile phones in GSM or GPRS networks uses an efficient installation algorithm with an error recovery mechanism. A digital signature is used for checking authenticity and integrity of the downloaded DSP software patch.

### BACKGROUND OF THE INVENTION

The present invention relates generally to wireless communication systems, and more particularly, to a method of remotely updating the operating software or feature set of a wireless electronic device by transmitting the update over the air (OTA).

There has been a tremendous proliferation of hand held electronic devices. As technology advances, allowing for increased processing power and greater memory, more and more sophisticated software is being used to operate such devices. The increased software content on these devices comes fraught with the risk of containing buggy code leading to disruption of service to the consumer. Also, more and more software-implemented features are becoming available for communications devices, such as Software Defined Radio (SDR).

A number of issues related to managing the software on these devices via re-programming, quality of service and other similar problems are being addressed and discussed extensively. Mobile device software management includes operations such as application provisioning, application management and software upgrades. Software upgrades are used for adding new functionality, enhancing existing features, adding new features, and fixing bugs. Providing software upgrades leads to a need to manage the software in an innovative way to contain costs and sustain revenues.

Presently, mobile device software management is done off-line at a customer care center or at the factory. The disadvantage with this approach is that the user has to personally visit the customer care center and surrender the mobile device for maintenance. This results in unavailability of the mobile device to the user for that particular period and increased costs of maintenance to the mobile device manufacturer and the operator. As the mobile device user population has grown, this task of offline-management has become tedious and expensive.

The present invention provides a solution to the difficulty of maintaining and upgrading electronic device software.

### BRIEF DESCRIPTION OF THE DRAWINGS

The following detailed description of a preferred embodiment of the invention will be better understood when read in conjunction with the appended drawings. For the purpose of illustrating the invention, there is shown in the drawings an embodiment that is presently preferred. It should be understood, however, that the invention is not limited to the precise arrangement and instrumentalities shown. In the drawings:

FIG. 1 is a simplified diagram showing elements involved in OTA (Over The Air) software management;

FIG. 2 shows an architecture of a solution for OTA Mobile Device Software Management in accordance with an embodiment of the present invention;

FIG. 3 shows an example of a package exchange between a Management Server and a Management Client for a DSP software upgrade in accordance with an embodiment of the present invention;

FIG. 4 shows a patch profile as a stack in a J2ME environment in accordance with an embodiment of the present invention;

FIG. 5 shows a patch packet format in accordance with an embodiment of the present invention;

FIG. 6 illustrates the flow for a DSP software upgrade in accordance with an embodiment of the present invention;

FIG. 7 shows an architecture for OTA Mobile Device Software Management in accordance with an embodiment of the present invention;

FIG. 8 shows an OTA ROM software patching process in accordance with an embodiment of the present invention;

FIG. 9 shows memory blocks reserved for storing a DSP Patch in a mobile electronic device in accordance with an embodiment of the present invention;

FIG. 10 shows a Patch Version Table and DSP Patch Data of the DSP Patch Blocks in accordance with an embodiment of the present invention;

FIG. 11 is a high-level flow diagram of interaction between an MCU and a DSP during DSP Patch loading, with the commands being sent by a DSP patch loader, in accordance with an embodiment of the present invention;

FIG. 12 is a Patch Download Component Diagram in accordance with an embodiment of the present invention;

FIG. 13 is a flowchart of a DSP Patch Installation Algorithm in accordance with an embodiment of the present invention; and

FIGS. 14-17 are flowcharts of the state transitions of the DSP Patch Installation Algorithm of FIG. 13.

### DETAILED DESCRIPTION OF PREFERRED EMBODIMENTS

The detailed description set forth below in connection with the appended drawings is intended as a description of the presently preferred embodiment of the invention, and is not intended to represent the only form in which the present invention may be practiced. It is to be understood that the same or equivalent functions may be accomplished by different embodiments that are intended to be encompassed within the spirit and scope of the invention. The terms mobile electronic device and wireless device are used interchangeably to refer to electronic devices that send and receive information using RF communications methods. Such devices include, for example, cellular telephones, portable computers, and other hand-held devices like personal digital assistants (PDAs). In the drawings, like numerals are used to indicate like elements throughout.

The present invention provides a client based software method for upgrading or patching ROM software of a processor of a mobile electronic device by OTA downloading patch software to the device and then installing the patch software on the device in a secure manner. A patch server hosts the patch software. The patch software is downloaded by a patch agent application running on the mobile device. In one embodiment, the patch server initiates the patch download by sending a notification message to the mobile device. The notification message invokes the patch agent application on the mobile device. The patch agent application sends negotiation parameter values to the server and the server determines whether the mobile device requires a particular patch and if the device has enough resources to download and install the patch. The patch agent carries out an installation process, which replaces an existing patch with a new patch in a non-volatile memory of the mobile device. Once started, the patch installation proceeds automatically. The patch installation operates in a fail-safe manner that prevents a partial or corrupt installation from rendering the system inoperable (i.e., crashing the software on the mobile device).

The present invention also provides a system for OTA downloading a patch program to a mobile device including a server having software for downloading a software patch and initiating installation of the software patch on the mobile device, a patch agent on a mobile device for installing the downloaded patch software on the mobile device in a fail safe and error-recoverable manner. More particularly, a patch server for over-the-air (OTA) updating of processor software of a client, wireless electronic device, includes a patch server application that communicates with client devices via an OTA interface, a patch program database in communication with the patch server application, and a patch data generator in communication with the patch program database. The patch server application initiates a patch download to a client device by sending a patch notification message to the client device that initiates a patch agent application on the client device. The patch program database stores a plurality of downloadable patch programs for downloading to the client devices. The patch data generator generates the downloadable patch programs by encoding predetermined patch data. The present invention enables a manufacturer to upgrade ROM software of mobile devices for bug fixes, feature enhancement or new feature introduction without recalling the mobile devices.

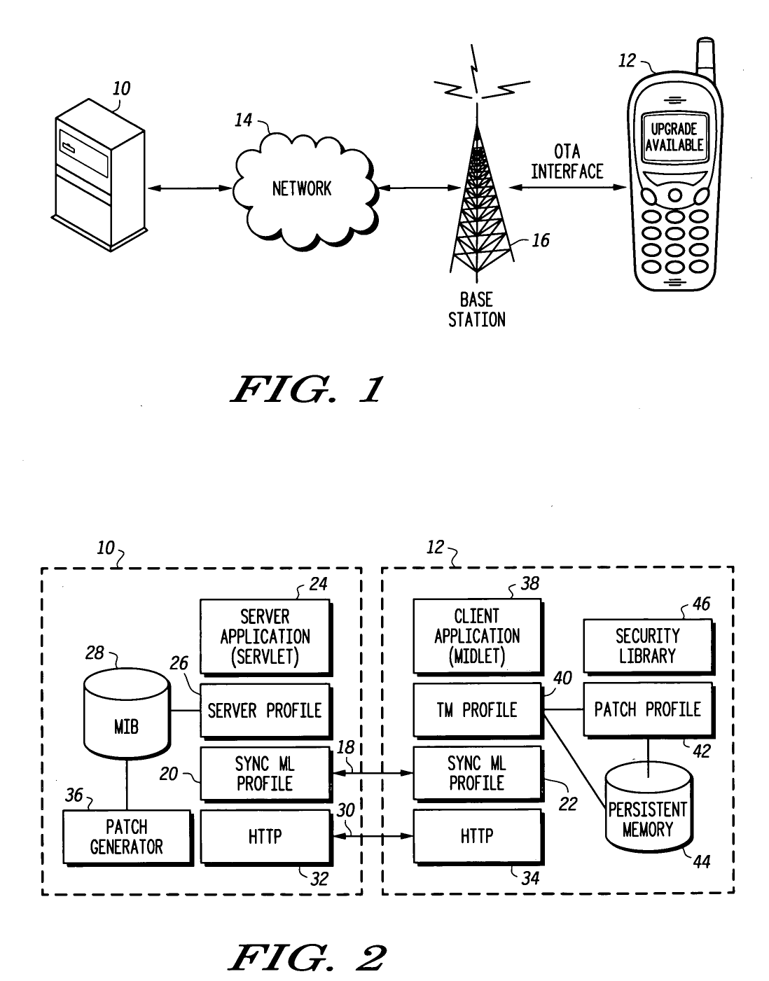

Referring now to FIG. 1, a simplified diagram showing elements involved in OTA (Over The Air) software management is provided in which a patch server 10 communicates with a plurality of wireless electronic devices 12 (one of which is shown) by way of a wireless network 14. As is understood by those of skill in the art, wireless networks include one or more base stations, such as a base station 16 shown in the drawing. The patch server 10 can be any computer that is connected to a wireless network, such as the network 14, and can transmit and receive messages by way of the network. The wireless devices 12 can be any type of wireless device, such as a mobile communication device, e.g., a cell phone, a personal digital assistant, etc. The wireless device 12 has a processor, such as a digital signal processor (DSP) and associated software that allows the device 12 to perform predetermined functions. The patch server 10 transmits a patch, which may include bug fixes, feature enhancements, new features, etc., to the wireless device 12 by way of the network 14.

FIG. 2 is a schematic block diagram of the software architectures of the patch server 10 and the wireless device 12. The patch server 10 and the wireless device 12 preferably communicate by way of a predetermined protocol. In one embodiment of the invention, the patch server 10 and the wireless device 12 communicate using the SyncML protocol, as indicated at 18. The SyncML protocol is a data synchronization and device management open standard that drives data mobility by establishing a common language for communications between devices, applications and networks. The SyncML standard is sponsored by a number of well-known companies, including Motorola Inc., the assignee of the present invention, and is supported leading wireless companies. As shown in FIG. 2, both the patch server 10 and the wireless device 12 include respective SyncML profiles 20 and 22. The SyncML profiles 20 and 22 implement the SyncML Management Protocol. The SyncML profile implementation of client and server interfaces according to the SyncML DM (Device Management) protocol. The SyncML profile 20 generates SyncML messages to be sent to the client (i.e., the wireless device 12) and parses received SyncML messages. The SyncML profile 22 acts in the same manner. The SyncML profile 22 defines sets of APIs and features to provide wireless device applications such as callbacks, GUI interface, and management objects interface across the network. As will be understood by those of skill in the art, the patch server 10 and the wireless device 12 have a client-server relationship.

In the embodiment shown, both the server and client side components fall into three basic categories, namely, user interface, device management, and data repository management. The patch server 10 includes a server application 24 that provides an operator interface, such as a web-based Graphical User interface (GUI), that allows an operator to set a management operation for a specific device. For example, an operator can select a particular software version of an application to be distributed to a particular type of devices. As will be discussed in more detail below, the server application 24 then initiates the software upgrade or another management operation by sending a notification message to the wireless device 12. The server application 24 can be implemented as a Java servlet. However, as will be understood by those of skill in the art, the server application can be implemented in other HTTP (Hypertext Transport Protocol) environments like CGI, ASP etc.

The patch server 10 includes a server profile 26 that provides access to appropriate data stored in a management information base (MIB) 28 during a SyncML management session with a wireless device 12. The patch server 10 and the wireless device 12 further communicate via the HTTP protocol, as evidenced by line 30. Accordingly, the patch server 10 and the wireless device 12 include respective HTTP modules 32 and 34. Although the HTTP transport protocol is a preferred transport protocol, it is possible to use a different transport protocol for completing the communication between the client 12 and server 10.

The MIB 28 contains information for each type of wireless device for which the patch server manages software updates. The MIB 28 also stores a plurality of different software patches that the various wireless devices will download. The MIB 28 is in communication with a patch generator 36. The patch generator 36 generates the downloadable patch programs by encoding predetermined patch data. The predetermined patch data includes patch software and its corresponding license. Both the patch software and its corresponding license are stored in the MIB 28 along with other predetermined patch data encoded by the patch generator 36, such as a description of the patch, patch program version number, associated wireless device model identifier, a ROM version number, a processor identification number and resource requirements for installation of the patch on the wireless device 12. The patch generator 36 also preferably assigns a unique identifier to each new patch generated, such as the patch program size or a checksum.

The wireless device 12 includes a client application 38. The client application 38 is a MIDlet application that presents a user interface to the wireless device user and accepts user input as required. The client application 38 is needed to initialize the SyncML profile 22 for exchanging SyncML packages with the patch server 10. The wireless device 12 also includes a TM profile 40 that executes commands specified by the patch server 10. Some command execution may require invoking native applications or methods, which is accomplished by using JNI (Java Native Interface). The TM profile 40 uses Patch Profile Services for software patch storage and software patch installation services. The TM profile 40 is initialized by the client application 38 for executing a device management command specified by the patch server 10.

The wireless device 12 includes a patch profile 42. The patch profile 42 provides those services required for a software upgrade. The patch profile 42 is designed in a generic way so that it can be extended easily for different software patch types. The patch profile 42 maintains version information of all upgradeable software applications on the wireless device 12. The patch profile 42 also keeps track of available resources for download and installation of a new patch. The version and resource information is sent to the patch server 10 during SyncML message exchange, as described below, so that the patch server 10 will be able to determine whether or not the wireless device 12 requires a certain patch.

The patch profile 42 stores downloaded software patches in a Flash or persistent memory 44 of the wireless device 12. The patch profile 42 is able to manage storage of multiple patches. Further, the patch profile 42 verifies the authenticity and integrity of a downloaded patch by using the patch license downloaded along with the patch. If confidentiality of the patch is important for a wireless device manufacturer, the patch can be encrypted and then the encryption information can be provided in the license.

The Flash memory 44 is re-programmable persistent memory. The wireless device configuration parameters and upgradeable application software are stored in the Flash memory 44. The TM profile 40 and patch profile 42 reprogram the flash memory 44 to set new configuration parameters and upgrade the device software. The patch profile 42 ensures that a patch installation procedure proceeds automatically and is managed in a fail-safe manner that prevents partial or corrupt installation from crashing the system or otherwise rendering the wireless device inoperable. Since a software upgrade could include or be for one or more system critical components, any corruption during the software upgrade process may render the device 12 unusable. Once installation is started, the patch profile 42 ensures that the installation procedure is completed.

The mobile device 12 further includes a security library 46. Before installing a patch, it is important to verify the authenticity and integrity of the patch data. The patch profile 42 uses the security library 46 for such verifications. The patch profile 42 provides a Java wrapper around the security library 46. The patch profile 42 verifies the integrity and authenticity of a downloaded patch by passing the patch and the associated patch license to the security library 46. Support for confidentiality of the security library is optional.

The OTA software upgrade process of the present invention can be divided into three major functionalities, namely, Notification and Download Protocol for the patch, Storage and Installation of the patch on the wireless device 12, and Generation and Storage of the patch on the patch server 10. The Notification and Download Protocol, as discussed above, is implemented using common industry standards. The presently preferred embodiment uses SyncML for this functionality. To maximize reuse, the SyncML specifications are implemented in J2SE on the patch server side and J2ME on the client (wireless device 12) side. More specifically, MIDP (Mobile Information Device Profile) is used on the client side, since MIDP is a widely available implementation for J2ME based devices. The Storage and Installation of the patch on the wireless device 12 is platform dependant functionality. Implementation of this functionality can vary but the interface should remain the same. In one embodiment, J2ME is used at client side for defining Java APIs for this functionality. The Generation and Storage of the patch on the patch server 10 does not use a generic structure for the patch because the generation of the patch is specific to the wireless device type to be updated. The patch and its associated patch license are generated by the wireless device manufacturer and distributed to operators for hosting on the patch server 10.

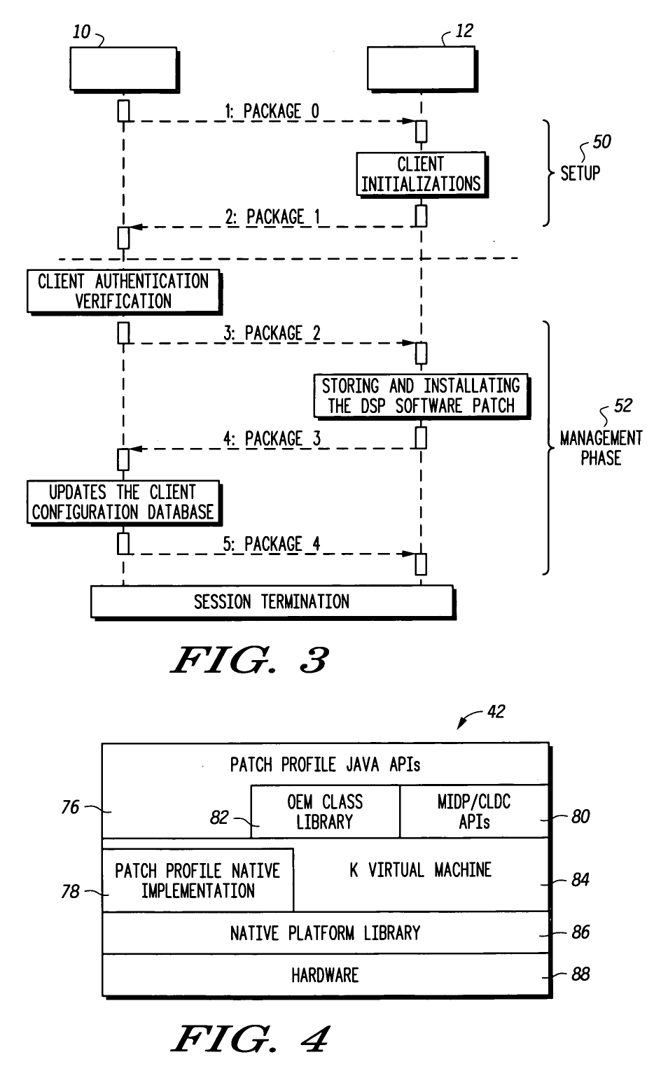

Referring now to FIG. 3, a SyncML package exchange between the patch server 10 and a wireless device 12 is shown. The patch download process complies with the SyncML Device Management protocol. There are two phases in a management session between the server 10 and the wireless device (client) 12, a setup phase 50 and a management phase 52. The setup phase 50 includes an exchange of packages (package0 and package1) between the server 10 and the device 12. Pakcage0 is required only when the server 10 initiates a management session. For a management session initiated by the device 12, the management session starts with package1. The management phase has a number of protocol iterations. Protocol iteration means a package from client to server and a package from server to client.

Whenever a new DSP patch is available for a device 12, the server 10 invokes an application on the device 12 by sending a SMS auto-launch message via SMS-C (package0). The SMS auto-launch message is parsed by an SMS engine in the device 12, which launches the client application. Package1, which is transmitted from the device 12 to the server 10, contains client authentication credentials and device information including DSP software version of the device 12.

Using the client authentication credentials and device information, the patch server 10 determines whether or not the device 12 needs the available patch. Considerations are the current software version and the DSP or processor version of the device 12. Another factor for consideration is any license agreement for certain devices. If it is determined by the patch server 10 that the device 12 should receive the patch, then the server 10 sends package2 to the device 12. Package2 includes the following information in a SyncML document, patch information (description of the patch), the patch itself, and a patch license. The information in package2 is then first stored on the device 12 and second installed on the device 12. Once the installation is complete, the device 12 sends the results of the installation back to the server 10 in package3. In response to receiving the package3, the server 10 signals the device 12 to terminate the management session (i.e., terminate the patch agent operating on the device 12) via package4. It should be understood that a large sized patch might span multiple SyncML packages. The SyncML Sync Protocol specifies how to handle large objects.

FIG. 6 is a diagram showing the packets exchanged for the case of the wireless device 12 or a user thereof requesting a patch from an operator managing the patch server 10. This is in contrast to the case shown in FIG. 3 where the patch download is initiated by the server 10. In FIG. 6, a user contacts a customer care center, such as via a voice call, and informs the customer care representative or operator that the wireless device 12 has a problem, such as poor voice quality, at 60. The operator searches a database including known problems and solutions for the wireless device 12 and determines that a patch is available for improving the voice quality problem at 62. The operator then instructs the patch server 10 to provide the patch to the device 12 at 64. At 66, the patch server 10 sends an SMS message (package0) to the device 12. In this case, receipt of the package0 invokes a patch agent on the device 12, as indicated at 68. At step 70, the device 12 and the server 10 then exchange packages with the server 10 sending the patch to the device 12, the device 12 installing the patch and then sending back to the server 10 the results of the patch installation. At 72, the patch agent is exited and the device 12 is rebooted. With the patch installed, the user notices the improved voice quality, as indicated at 74.

Referring now to FIG. 4, the patch profile 42 is shown as a stack in a J2ME environment. The patch profile 42 is concerned with fail-safe installation of the downloaded patch, extensibility, and reusability. As understood by those of skill in the art, installation of native software such as DSP software is a very platform dependant task. To achieve the above design goals and to separate out platform dependant parts of the patch profile from platform independent parts, the patch profile 42 is divided into two parts, Java APIs 76 and a native implementation 78.

The patch profile Java APIs 76 is the platform independent part of patch profile, which exposes a set of APIs to the TM profile 40 and other applications. The Java APIs 76 perform platform independent tasks such as storage management of the patch and its license. For platform specific tasks, which require native method execution, the patch profile native implementation 78 is called via a Java Native Interface. The Java APIs 76 are designed in a generic way so that they handle different types of patches without any changes in the exposed Patch Profile APIs. The Java APIs 76 are LCC (Licensee Closed Class).

The patch profile native implementation 78 includes the native code required to install a particular type of patch and gather version and resource information for a particular type of patch installation, available memory space for the installation process and installation of the DSP patch. The installation process includes error recovery routines that allow recovery of installation when an error occurs, like power failure or system crash.

The patch profile 42 also includes MIDP/CLDC APIs 80, an OEM class library 82, a Kvirtual machine (KVM) 84, a native platform library 86, and a hardware platform 88. The MIDP/CLDC APIs 80 are standard APIs available for MIDlet development. The OEM Class Library 82 provides specific APIs required by a certain platform (i.e., functionality specific), but that are not included as part of the MIDP/CLDC APIs 80. The KVM 84 is a compact, portable Java virtual machine intended for small, resource-constrained devices such as cellular phones, pagers, personal organizers, mobile Internet devices, and so forth. All native functions accessed by Java code are part of the KVM 84 implementation. The native platform library 86 includes APIs provided by OS system calls and native libraries. The patch profile native implementation 78 uses the native libraries and OS system calls to perform installation specific tasks, such as flash programming routines for re-programming upgraded DSP software. The hardware platform 88 is the device 12 hardware. An example hardware platform 88 is the 280i cellular telephone manufactured by Motorola Inc. of Schaumburg, Illinois.

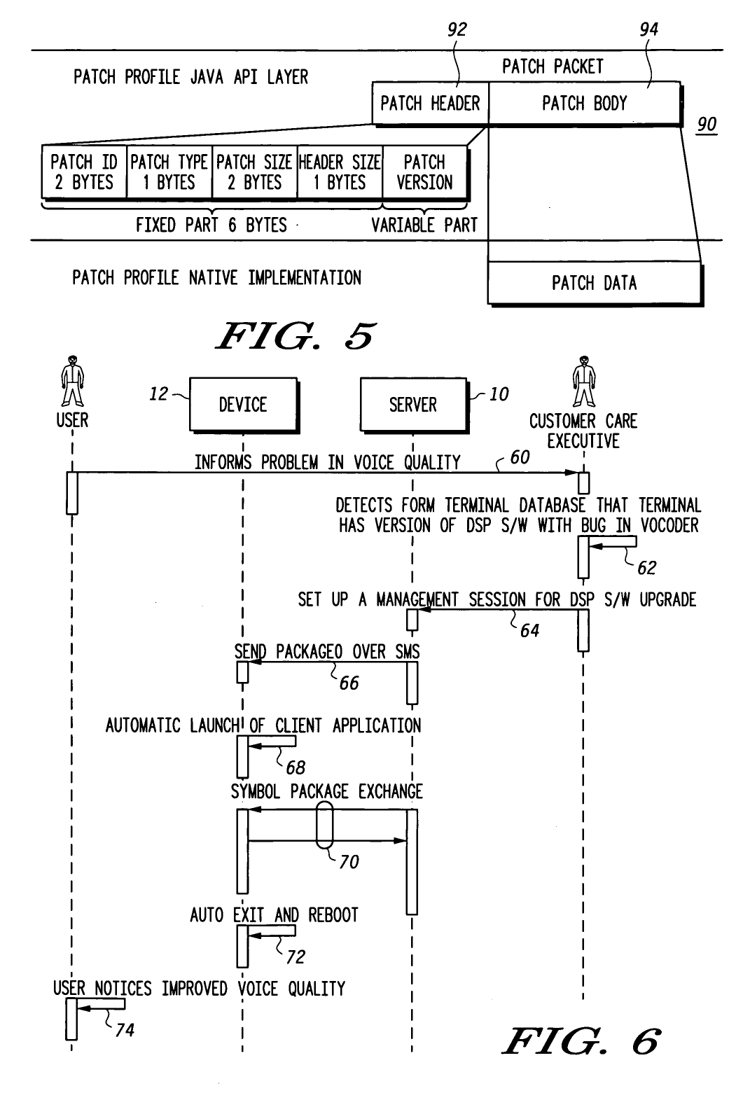

FIG. 5 shows the format of a patch packet 90. The patch packet 90 includes a patch header 92 and a patch body 94. The patch header 90 gives the “type” information of the patch used by the patch profile 42 to call corresponding storing and installing functions. In the embodiment shown, the header 90 includes six byte fixed part and a variable part. The fixed part includes a two-byte patch identifier, a one-byte patch type field, a two-byte patch size field, and a one-byte header size field. The variable part can be used to hold a patch version identifier.

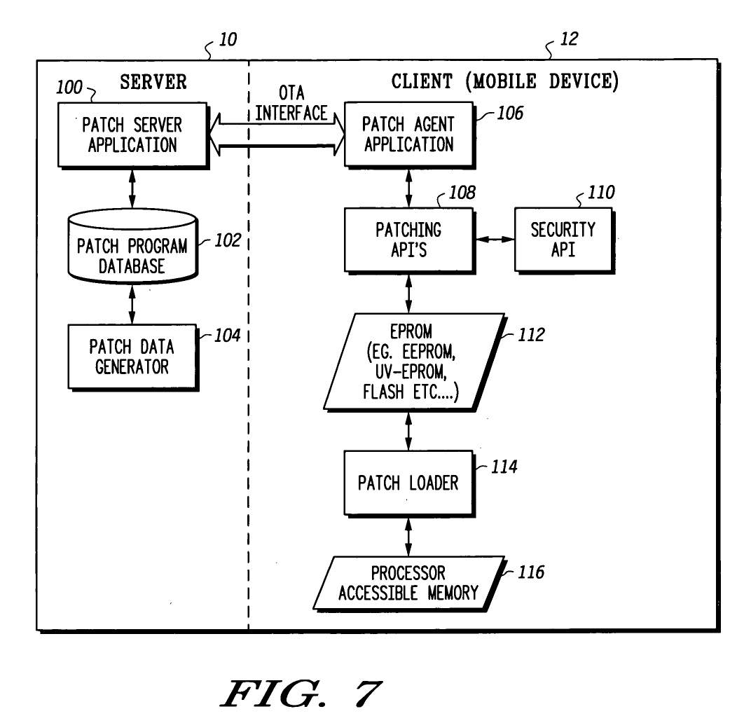

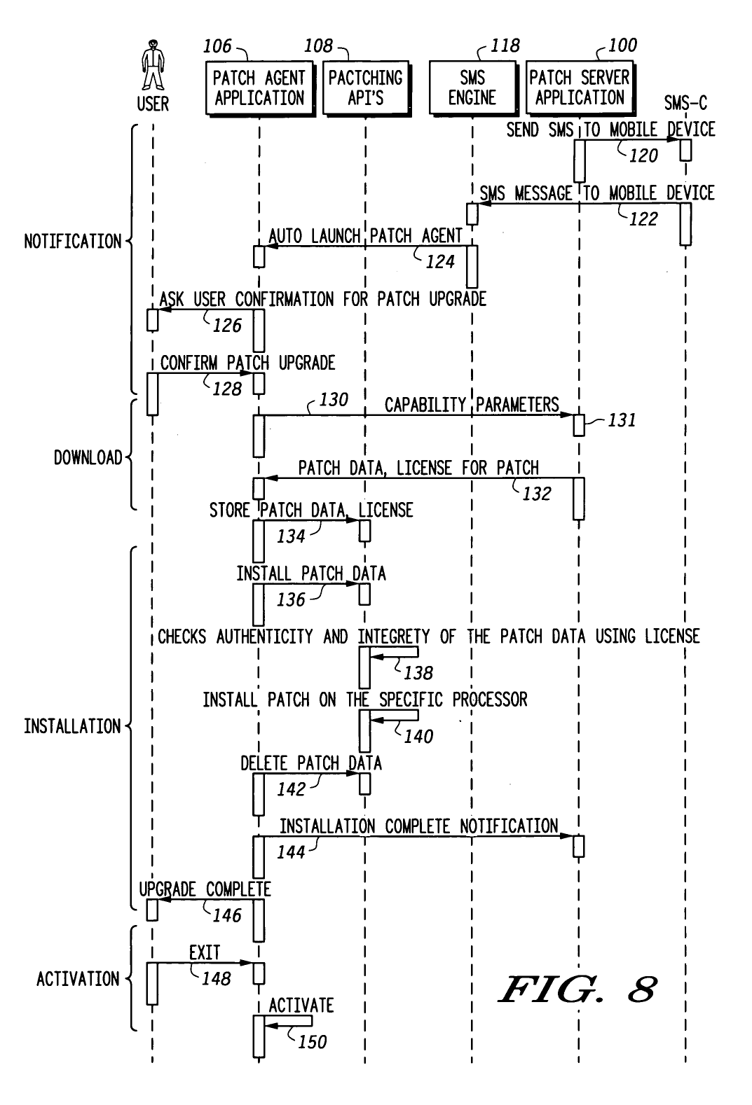

A more detailed description of the patch installation procedure will now be described with reference to FIG. 7, which shows an architecture for OTA Mobile Device Software Management in accordance with an embodiment of the present invention. In this embodiment, the patch server 10 includes a patch server application 100, a patch program database 102 and a patch data generator 104. The wireless device 12 includes a patch agent application 106, patching APIs 108, a security API 110, a first memory 112, such as an EPROM, EEPROM, UV-EPROM, Flash, and the like, a patch loader 114, and a second, processor accessible, memory 116.

The patch server application 100 maintains storage of various DSP patches in the patch program database 102 and communicates with the patch agent application 106 for DSP patch upgrades. The patch server application 100 can initiate a patch download session with the patch agent application 106 by sending a notification message to the patch agent application 106, as previously discussed with reference to FIG. 3. The notification message launches the patch agent application 106 on the wireless device 12, which in turn starts the download session. The patch server application 100 has to receive at least the following capability negotiation parameters from the patch agent application 106: Mobile Device Model ID; Versions of currently installed patch on the mobile device for all processors on the mobile device; ROM software version being patched; and Free Storage Space available in the first memory 112. The above parameters are necessary for the patch server application 100 to check if the wireless device 12 needs a software patch, if it is able to upgrade the wireless device 12 (e.g. the database 102 contains new patches for the device 12) and if the resources available on the device 12 allow the execution of a patch procedure (e.g. enough memory resources are available at the moment). The patch server application 100 can be a web-server application or any other server application, which can be accessed by the patch agent application 106 of the mobile device 12 in a given mobile network. The patch server application 100 can be an independent application or a functionality of another server application.

The patch program database 102 is a database for different patch program releases. There is a unique patch ID associated with each patch stored in the database 102. Several other parameters also are stored with a particular patch program release, including: ROM Version (version of the ROM to be patched by the patch program), Processor ID (Identifier for processor on a mobile device in case there are multiple processors that can be patched on a particular mobile device), and a License File. The license file/certificate corresponds to the patch program so that the patch agent application 106 can verify authenticity and integrity of the patch program. If the patch program is encrypted due to a confidentiality requirement as specified by the license file, then the license file will contain cryptographic information to decrypt the patch program on the wireless device 12. Advanced software/content distribution concepts like digital rights management (DRM) can also be used for security.

The patch data generator 104 generates the patch data and the License file for the patch data. The patch data generator 104 also performs required encoding of the patch data and the license file for network transmission. The generated and transmitted patch data is a patch program converted into specific format so that the patch agent application 106 can load the patch into the wireless device processor's accessible memory along with following information: ROM version being patched, ID of processor to which the patch is being installed, Version of the patch program, and Size of the patch program. Where the processor can access the first memory 112 directly and can execute code from the memory 112, the patch data is the patch program along with above information.

The patch agent application 106 resides on the wireless device 12 and communicates with the patch server 10 for downloading the patch data from the server 10. Once the patch data is downloaded, the patch agent application 106 uses the patching APIs 108 to store the patch data on the device 12 and then install the patch program on the device 12. The patch agent application 106 can be an independent application or can be a functionality of some other application on the wireless device 12.

The patching APIs 108 provide services to end user applications for storing the downloaded patch data and installing that patch on the mobile device 12. The patching APIs 108 manage storage of the patch on the device 12 and manage the installation process. Once in process, the patch installation process proceeds automatically. The patching APIs 108 are implemented as a native library or as a Java library. Before installing the patch data on the wireless device 12, it is important to verify the authenticity and integrity of the patch data to prevent corrupted or malicious code being installed on the device 12. The security APIs 110 provide services to other software components to perform these check operations. That is, the security APIs 110 check the authenticity and integrity of the downloaded patch data using the license file downloaded from the server along with the patch data. If the patch data is encrypted due to a confidentiality requirement, the license file contains the cryptographic information required to decrypt the patch program on the wireless device 12. As discussed above, DRM may also be used.

The first memory 112, which may be an EPROM is persistent storage in the wireless device 12 where patch programs are stored persistently. Various types of EPROM are used in wireless devices, like Electrically Erasable Programmable Read Only Memory (EEPROM), Ultraviolet Erasable Programmable ROM (UVEPROM), and flash memory etc. The wireless device 12 also includes processor accessible memory 116, which is the memory where the patch program is loaded for execution. If a processor can directly access the first memory 112, the second memory 116 is not required.

The patch Loader 114 is the software component responsible for loading the patch data into RAM of the processor so that the processor can execute the patch programs instead of some specific code in the processor ROM. The patch loader 114 may not be required in a system where the processor being patched can directly access the first memory 112 and can execute the patch programs from the first memory 112, itself. In one embodiment, the patch loader 114 is implemented on the processor being patched and in an alternate embodiment, the patch loader 114 is implemented on another processor of the mobile device 12.

Referring now to FIG. 8, an end-to-end example of an OTA ROM software patching process is shown with a high-level message sequence chart. FIG. 8 shows that the OTA ROM software patching is divided into four major phases, notification, download, installation and activation. Each of these phases is described below.

The notification phase occurs first. Whenever a new patch is available for a mobile device, the patch server application 100 invokes the patch agent application 106 on the wireless device 12 by sending a SMS or any other notification message supported by the mobile device 12, which will auto-launch the patch agent application 106. Line 120 indicates the patch server application 100 generating a SMS notification message. The server 10 then sends the SMS notification message via SMS-C and parsed by an SMS engine 118 on the wireless device 12, which in turn launches the Patch Agent Application 106, as indicated at 124. At step 126, the patch agent application 106 requests the user to confirm the downloading and installation of a patch. The user confirmation request is performed by displaying a message on the display screen of the device 12 and waiting for a user input. Upon the user confirming the patch download request at step 128, the download phase is initiated.

In the download phase, the Patch Data and License file for the new patch are downloaded and stored on the wireless device 12 using available bearer service of the wireless device 12. At step 130, the patch agent application 106 sends capability parameters to the patch server application 100 before the patch data is transmitted back to the device 12. At step 131, the patch server application 100 checks the capability negotiation parameters values sent by the patch agent application 106 and then at step 132 sends the patch data and license file to the device 12, as long as the capability parameters match the criterion for new patch download and installation. The patch agent application, at step 134, stores the downloaded patch data using the patching APIs 108.

Next is the installation phase. At step 136, the patch agent application 106 uses the patching APIs 108 to install the patch on the device 12. The patching APIs 108 check for which processor the particular patch is for and performs security checks using the security APIs 110 at step 138. The patching APIs then update the existing patch data stored in the first memory 112 with the downloaded patch data in a fail-safe manner, so that unexpected errors like a power-failure do not render the device 12 inoperable at step 140. The fail-safe algorithm ensures the availability of the already installed patch program or null patch program to the processor being patched, in case of some unexpected failure during new patch installation. This requires managing the backup of an already installed patch and providing a reference to the backup area, as well as recovery from a corrupt installation and completion of the installation of the new patch. Once the patch installation is completed, the stored patch data is deleted at step 142 and an installation complete notification message is sent to the patch server 10 at step 144. In addition, a message is sent to the user (via the display screen of the device 12) at step 146.

After installation, the patch is activated. The newly installed patch is said to be active only when the patch loader 114 loads the new patch to the processor RAM for execution and the patch agent application is exited, step 148. In one embodiment, activation requires warm-boot of the device 12, as indicated at step 150.

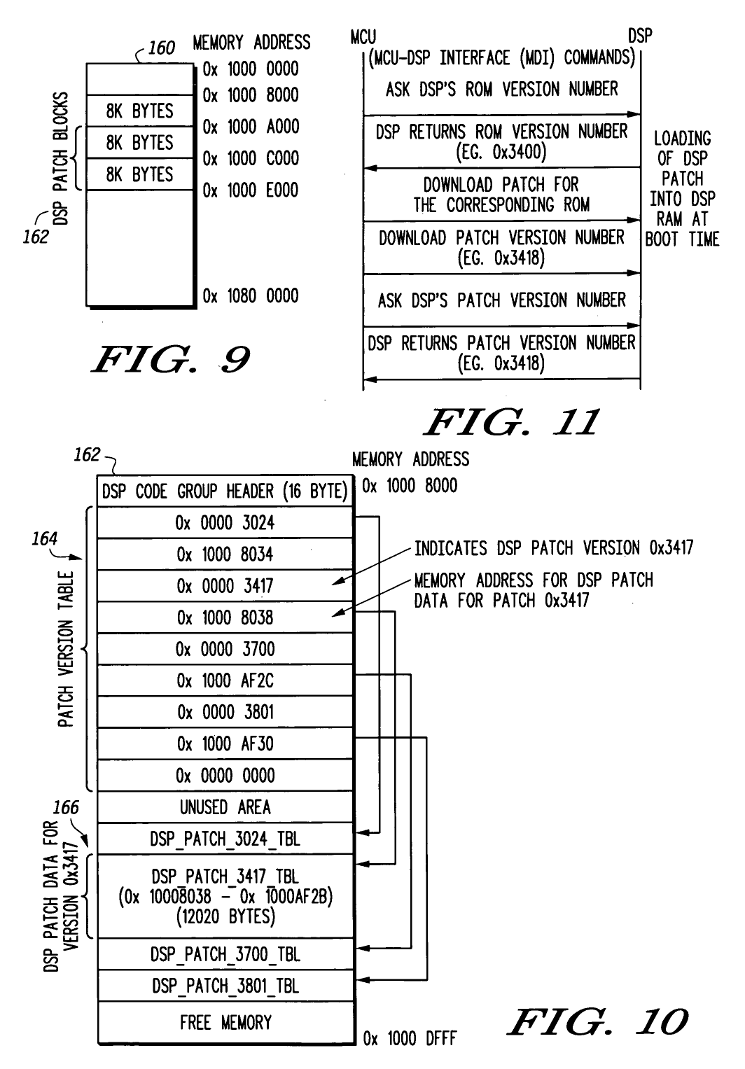

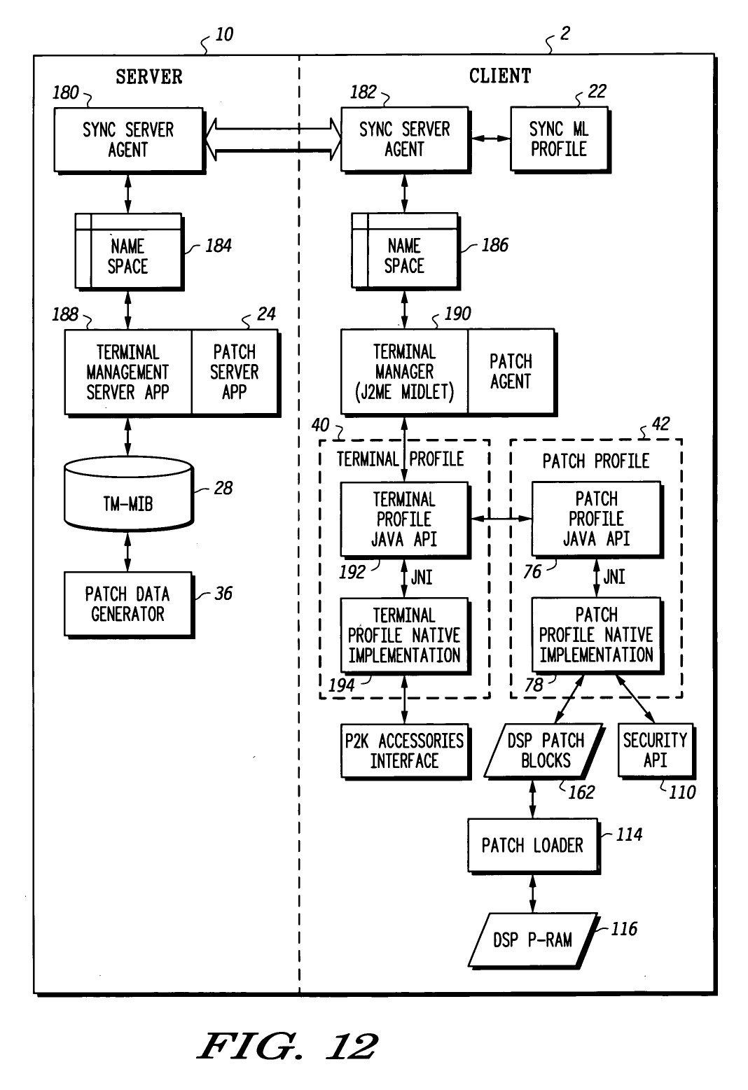

Referring now to FIGS. 9 and 10, a DSP program memory is shown in which a DSP patch is installed in accordance with an embodiment of the present invention. At a higher level, a DSP patch is a set of functions, loaded in to the program RAM (P-RAM) of the DSP at the boot time and executed in lieu of specific functions/code in the DSP Program ROM (P-ROM). The DSP Patch can be a feature enhancement or a bug fix to existing code in the DSP P-ROM. The DSP Patch may be stored in flash memory and later loaded into the P-RAM. As mentioned above, a DSP Patch has to be loaded into P-RAM from a non-volatile storage each time the DSP boots. The patch loader 114 performs the process of loading the DSP patch from the Flash Memory to the P-RAM when the device 12 is booted. Specific memory blocks are reserved for storing a DSP patch in the Flash memory, known as DSP Patch Blocks. FIG. 9 shows a Flash memory 160 of a DSP in which three memory blocks 162 of 8kB each are reserved for storing a DSP Patch.

FIG. 10 shows a memory map of the DSP patch blocks 162 shown in FIG. 9. The DSP patch blocks 162 include a patch version table (PVT) 164 and a patch data area 166. Multiple DSP Patches may be stored in the DSP patch blocks 162. An index of all DSP patches stored in the DSP patch blocks 162 is maintained in the PVT 164. The PVT 164 contains a DSP Patch Version for a particular patch followed by memory address of DSP Patch Data for that particular patch, as shown in FIG. 10. A DSP Patch Version number, which is a two-byte integer, is stored in the PVT 164. In this example, a DSP patch having a version number of 0×3417 is shown. The first two digits of the version number indicate the DSP ROM version to which the patch corresponds and the last two digits indicate the revision number of the patch. For example, for DSP Patch Version 0×3417, then the patch is for DSP ROM Version 0×34 and it is a 0×7th revision of the patch. After the PVT 164, the rest of the area in the DSP patch blocks 162 the patch data area 166, which is used to store Patch Data for the latest patches for different DSP ROM versions.

FIG. 11 is a high-level flow diagram of interaction between an MCU and a DSP during DSP Patch loading, with the commands being sent by the DSP patch loader 114, in accordance with an embodiment of the present invention. A DSP Patch is not stored in its object format in the flash memory, but as a series of MDI messages that are converted to DSP object code by the patch loader 114. In operation, the patch loader 114 queries the DSP for its ROM version and scans the PVT 164 to locate an entry for a DSP Patch corresponding to the DSP ROM version. After locating the DSP Patch Data for that particular patch, the patch loader 114 loads the patch to P-RAM from the DSP Patch Blocks 162 using long MDI (MCU-DSP Interface) messages of DSP Patch Data. Once the patch is loaded into P-RAM, the patch loader 114 queries the DSP for its patch version number to verify that the patch is loaded in P-RAM correctly.

To upgrade a DSP Patch on wireless device 12, the DSP Patch Data 166 and PVT 164 in the DSP Patch Blocks 162 of the flash memory 160 must be updated with new DSP Patch Data and a new PVT. In the presently preferred embodiment, OTA DSP Patch Upgrade allows an end user to download DSP Patches and install the patches on the device 12 securely. Since the DSP Patch Loader 114 loads a patch from the DSP Patch Blocks 162 in the flash memory 160 to the P-RAM of the DSP at boot time, installation of a new DSP patch requires replacing the current DSP Patch Data with newly downloaded DSP Patch Data and updating the PVT 164 with the new patch version. So, essentially OTA DSP Patch upgrade requires OTA download of new DSP Patch Data and reprogramming of the DSP Patch Blocks with the newly downloaded DSP Patch Data and a new PVT.

Referring now to FIG. 12, a Patch Download Component Diagram is shown for explaining the Terminal Management (TM) architecture and how a DSP Patch Upgrade is integrated with the Terminal Management components. The shaded components are particular to the OTA ROM software patching architecture of the present invention. As previously discussed with reference to FIGS. 2 and 7, the server 10 and the wireless device (client) 12 transmit data back and forth using the SyncML format over an HTTP interface. Thus, the server 10 includes a Sync Server Agent 180 that transmits and receives messages and the wireless device 12 includes a sync client agent 182 that similarly sends and receives messages. The Sync Client Agent 182 is a set of Java classes that handle the sending and receiving of SyncML messages in order to implement the SyncML protocol. A XML parser is used to parse the SyncML message and extract SyncML operations. Each SyncML message has a header that contains a session ID, source, target locations, and authentication information. Both the server 10 and the wireless device 12 include a Namespace 184, 186 that defines the name and value of the management objects using a management tree that organizes all available management objects, where all management objects are uniquely addressed with a URI.

The patch server application 24 is part of a Terminal Management Server Application (TMSA) 188, which is an application implemented using a Java Servlet to perform Terminal Management with Patch Download functionality. The TMSA 188 uses services provided by the Sync Server Agent 180 to extract the SyncML operations with the Namespace 184. The TMSA 188 also updates the data in the MIB 28. The Patch Download functionality of the TMSA 188 corresponds to Patch Server Application 100 shown in FIG. 7. The wireless device 12 has a Terminal Manager 190, which is a terminal management J2ME application for wireless devices. The Terminal Manager 190 uses services provided by the Sync Client Agent 182. The Terminal Manager 190 supports three main operations: terminal tracking, terminal configuration, and patch download. The patch download functionality of the Terminal Manager 190 corresponds to Patch Agent Application 106 shown in FIG. 7. As previously discussed with reference to FIG. 2, the Terminal Profile 40 contains device specific classes that allow SyncML software to access device-specific functionality such as persistent storage and management operation manipulation to retrieve or upgrade data from the storage. The terminal profile 40 has two categories of components, one of which is platform independent and compatible with other profiles, and another which is platform specific component and not compatible with other profiles. The terminal profile 40 thus includes Terminal Profile Java APIs 192 and a terminal profile native implementation 194. The Java APIs 192 are a set of Java classes to handle domain-specific functionalities to greatly enhance the capabilities of the terminal management application. Applications developed using these classes are portable across different MIDP devices. The Java APIs 192 use TM native implementation to take advantage of native functionality such as querying device information and sharing data with native applications. The TM profile Java implementation uses patch profile java APIs for storing and installing patch data on the device 12. The Terminal Profile Native Implementation 194 is the platform specific component written in platform dependent language. The native implementation 194 uses device layer modules to execute AT commands corresponding to management operations. The native implementation 194 is not portable and totally dependent on platform.

The Patch Profile 42 provides services for storing the downloaded patch data and installing the patch on the device 12. In the current implementation the terminal manager 190 downloads the patch data to be installed and uses the Patch Profile 42 to store and install the patch on the device 12. The Patch Profile 42 is generic so that support for a different patch type can be easily added. The Patch Profile 42 can be divided into two sub-components, Patch Profile Java APIs 76 and Patch Profile Native Implementation 78. The Patch Profile Java APIs 76 are platform independent. The Terminal Manager 190 uses the APIs 76 to store and install the patch. The Java implementation uses Patch Profile Native Implementation 78 to carry out platform specific task such as installation of a DSP Patch. The Patch Profile Java APIs 76 are LCC. The Patch Profile Native Implementation 78 is platform dependent and includes native code for installing a DSP Patch in the DSP Patch Blocks 162.

The security APIs 110 verify the authenticity and integrity of the patch data. The Native Implementation 78 of patch profile uses these security APIs to verify authenticity and integrity of the DSP Patch Data using the license file downloaded from the server 10. The security APIs 110 are currently implemented in C, but it is possible to have a Java wrapper class to access them from Java if the integrity and authenticity of the Java wrapper can be independently ensured. It is crucial to security that only trusted software be allowed to install patch data. It is also noted that MIDP 2.0 allows for MIDLETS to be signed by a trusted authority, which is an alternative method to ensure integrity and authenticity of the installer Java program and the patch data.

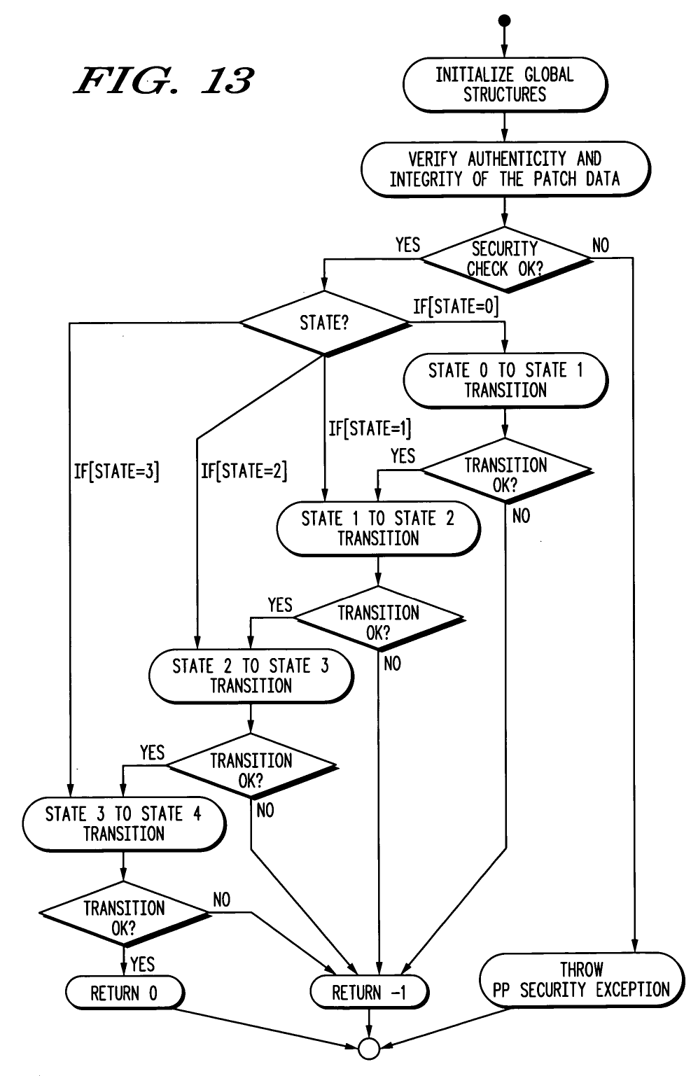

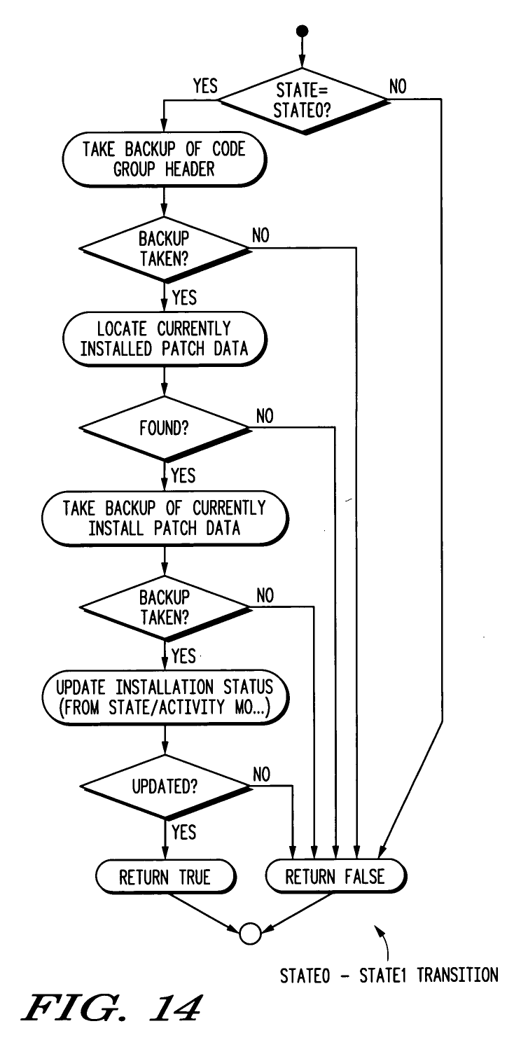

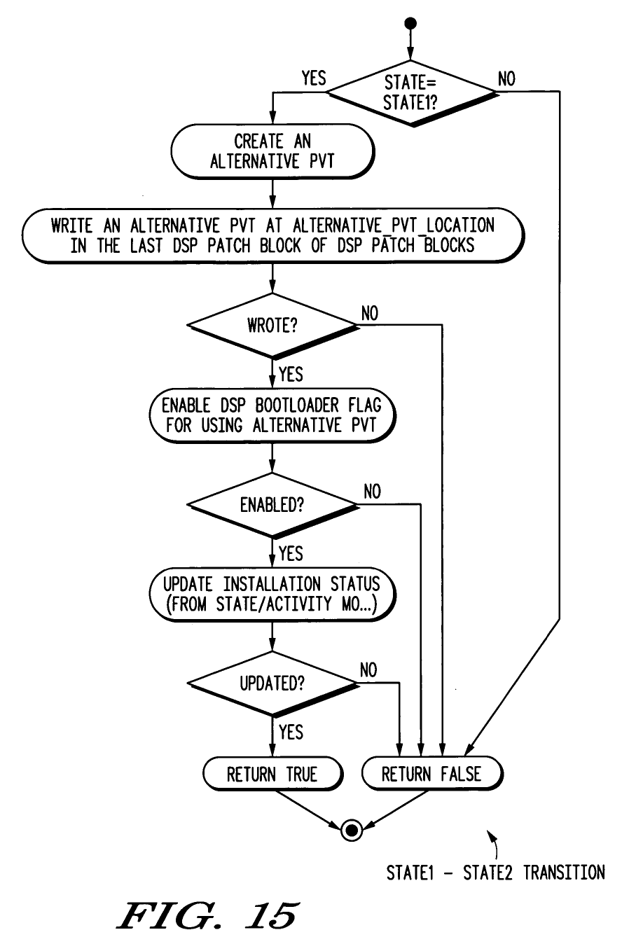

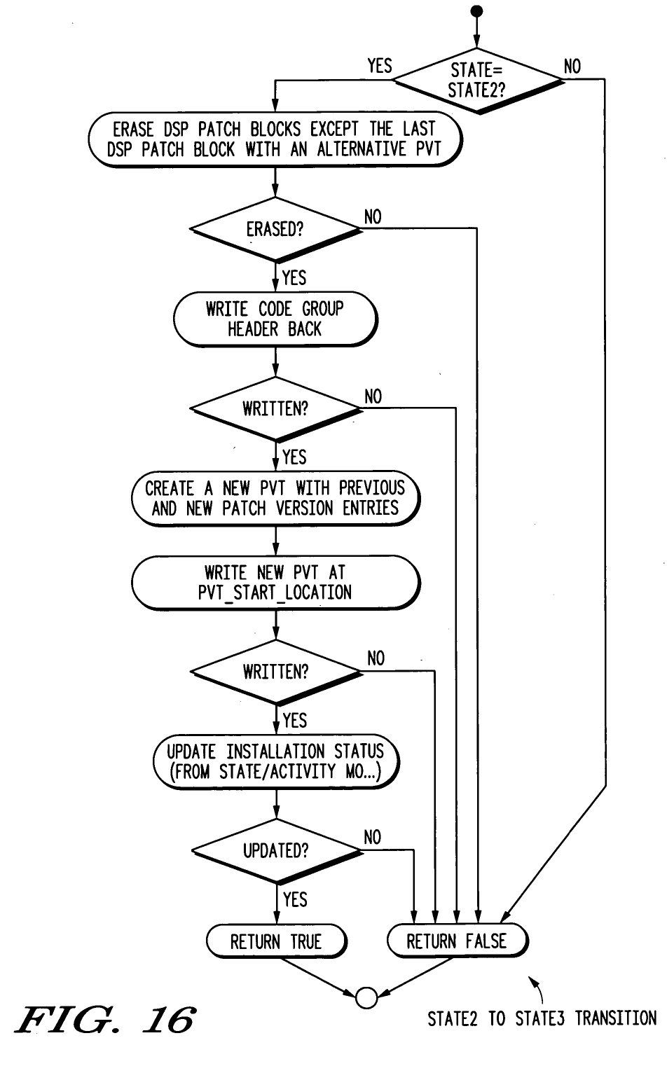

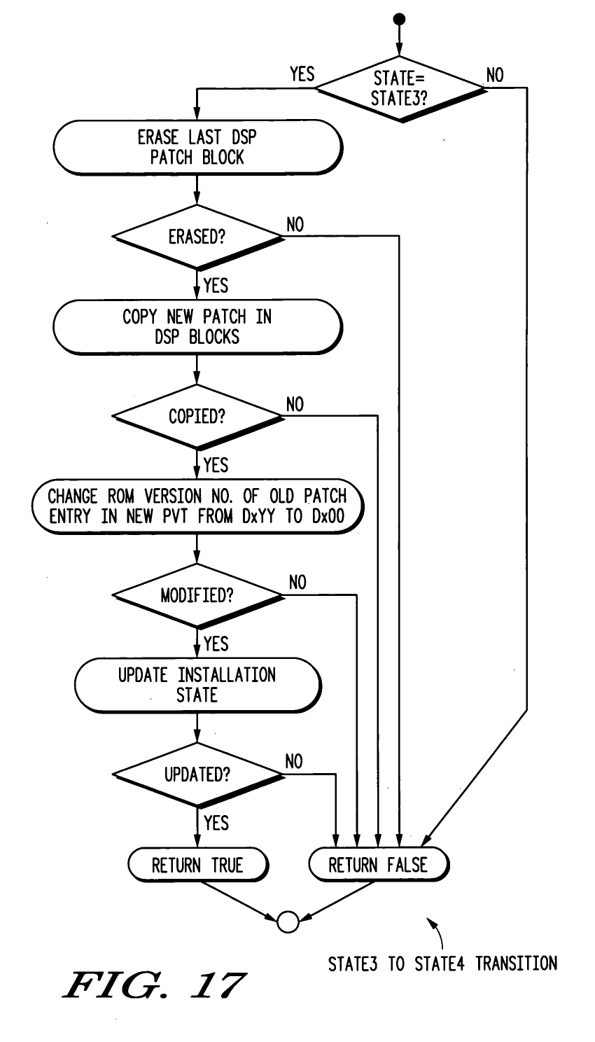

Referring now to FIGS. 13-17, in order to insure that the patch is installed in a fail-safe manner, certain installation states have been defined in the native implementation of the patch install. Several operations are performed during the transition from one state to another state. A particular installation state indicates all the operations to reach that state have been performed completely. The following installation states and operations are required to reach a state from its previous state: State0, Initial State (Old Patch is currently installed); State1, Backup of old patch is taken in flash memory; State2,Alternative Patch Version Table is created in the last DSP Patch Block and a DSP boot-loader flag is set; State3, Erased DSP blocks except last DSP Patch Block, New PVT is created and written at start of first DSP Patch Block; State4 (Final State), Last DSP Patch is erased and new patch data is written in space available on DSP Patch Blocks, and the PVT is modified to activate new patch. Each state transition can be considered atomic, either they are performed fully or if a system crash occurs before transition has been performed fully, that transition is re-started from the beginning without corrupting the data in the DSP Patch Blocks at the time of installation recovery. FIG. 13 is a flowchart of the DSP Patch algorithm and explains the overall algorithm at a higher level. Each state transition is explained in the subsequent detailed flow charts shown in FIGS. 14-17.

As will be apparent from the foregoing, software download is an efficient mechanism to support re-configurable features of any type of wireless device. The present invention discloses an architecture solution for managing the mobile radio software over the air for deployment of software modules (upgrades of DSP software) below the application level in mobile terminals. The description of the preferred embodiments of the present invention have been presented for purposes of illustration and description, but are not intended to be exhaustive or to limit the invention to the forms disclosed. It will be understood by those of skill in the art that changes could be made to the embodiments described above without departing from the broad inventive concept thereof. It is understood, therefore, that this invention is not limited to the particular embodiments disclosed.

TABLE 1
TABLE OF ABBREVIATIONS

| | |
|---|---|
| DRM | Digital Rights Management |
| DSP | Digital Signal Processor |
| DSP Patch | A DSP patch is a set of functions, loaded in to P-RAM |
| | (Program RAM) of DSP chip at the boot time of DSP |
| | and executed instead of specific functions/code in |
| | P-ROM (Program ROM) of DSP chip. |
| DSP Patch Blocks | Flash Memory blocks on Panther were the DSP Patch |
| | Data is stored. |
| DSP Patch Data | A DSP Object code for a DSP Patch is converted into |
| | series of long MDI messages and stored in DSP Patch |
| | Blocks. This converted format is known as DSP Patch |
| | Data. |
| Flash Memory | It is a non-volatile memory in a mobile terminal. |
| MCU | Micro Controller Unit |
| MDI | MCU - DSP Interface |
| MIB | Management Information Base |
| OTA | Over The Air |
| Patch Program | Patch Program is a function or set of functions being |
| | executed instead of the corresponding ROM code. |
| Patch Data | Patch program formatted in specific way for |
| | installation on the mobile device. |
| PatchID | Unique 2 bytes integer number assigned to a particular |
| | patch. |
| PP | Patch Profile |
| P-RAM | Program - RAM for Processor |
| P-ROM | Program - ROM for Processor |
| PVT | Patch Version Table is a table of Patch Version and |
| | location of their corresponding DSP Patch Data. |
| SyncML | SyncML is the leading open industry standard for |
| | universal synchronization of remote data and personal |
| | information across multiple networks, platforms |
| | and devices. |
| TM | Terminal Management. Terminal Management is a |
| | collection of client/server applications and functions, |
| | which allow operators/service providers the ability to |
| | remotely manage terminals in their networks. |

1. A method of over-the-air updating of software of a wireless electronic device by a server, comprising the steps of:
sending a patch notification message from the server to the wireless device, wherein receipt of the patch notification message initiates a patch agent on the wireless device;
the server receiving parameters of the wireless device from the wireless device;
the server determining a need for providing a predetermined software patch to the wireless device using the received parameters; and
sending a software patch to the wireless device in response to the determining step, wherein the software patch is received, stored and installed on the wireless device by the patch agent.

2. The method of over-the-air updating of software of a wireless electronic device by a server of claim 1, wherein the software patch comprises a software bug fix.

3. The method of over-the-air updating of software of a wireless electronic device by a server of claim 1, wherein the software patch comprises a feature enhancement.

4. The method of over-the-air updating of software of a wireless electronic device by a server of claim 1, wherein the software patch includes new software features.

5. The method of over-the-air updating of software of a wireless electronic device by a server of claim 1, further comprising the step of receiving from the wireless device a status message indicating a result of the software patch installation.

6. The method of over-the-air updating of software of a wireless electronic device by a server of claim 1, wherein the software patch contains patch software and a jump table entry.

7. A method of over-the-air (OTA) updating of processor software of a wireless electronic device by a server, comprising the steps of:
the server sending a notification message to the wireless device;
the server receiving capability negotiation parameter values from the wireless device sent to the server in response to the notification message;
the server analyzing the received negotiation parameter values to determine whether the wireless device has enough resources to receive and install a predetermined patch program;
the server transmitting OTA the predetermined patch program to the wireless device based on a result of the analyzing step, wherein a patch agent running on the wireless device executes an installation process on the wireless device that installs the predetermined patch program in a non-volatile memory of the mobile device and wherein once started, the patch installation proceeds automatically.

8. A patch server for over-the-air (OTA) updating of processor software of a client, wireless electronic device, the patch server comprising:
a patch server application that communicates with client devices via an OTA interface, wherein the patch server application initiates a patch download to a client device by sending a patch notification message to the client device that initiates a patch agent application on the client device;
a patch program database in communication with the patch server application, wherein the patch program database stores a plurality of downloadable patch programs for downloading to the client devices; and
a patch data generator in communication with the patch program database, the patch data generator for generating the downloadable patch programs by encoding predetermined patch data.

9. The patch server of claim 8, wherein each of the downloadable patch programs includes a unique patch identification number, a ROM version number, a processor identification number, and a license certification.

10. The patch server of claim 8, wherein the predetermined patch data encoded by the patch data generator includes a ROM version number, a processor identification number, a patch program version number, and a patch program size.
